(19) United States
(12) Patent Application Publication
(10) Pub. No.: US 2026/0240718 A1
(43) Pub. Date: Aug. 20, 2026

(54) MASSAGE DEVICE CAPABLE OF AUTOMATIC SLIDING

(71) Applicant: CERAGEM CO., LTD., Cheonan-si, Chungcheongnam-do (KR)

(72) Inventors: Dong Myoung Lee, Asan-si, Chungcheongnam-do (KR); Sang Ho Choi, Cheonan-si, Chungcheongnam-do (KR); Yong Seob Seo, Cheonan-si, Chungcheongnam-do (KR)

(21) Appl. No.: 18/993,972

(22) PCT Filed: Jul. 14, 2023
(86) PCT No.: PCT/KR2023/010072

§ 371 Date: Jan. 13, 2025

(30) Foreign Application Priority Data
Jul. 15, 2022 (KR) 10-2022-0087335

(51) Int. Cl. A61H 23/00; A61H 23/02

(52) U.S. Cl. CPC A61H 23/006; A61H 23/02; A61H 2201/0192

(57) ABSTRACT

A massage device capable of automatic sliding that can automatically move an auxiliary part supporting a lower body of a user includes a main body part having a first plate supporting the upper body of a user, a pair of side frames disposed on both sides of the first plate in a width direction, and a massage module for massaging the user, an auxiliary part connected to be slidable in a longitudinal direction of the main body part and having a second plate supporting the lower body of the user and a leg frame supporting the second plate for the second plate to be disposed apart from the ground, an automatic sliding part having a conveying member connected to the auxiliary part and a driving member providing a driving force for the conveying member to automatically move, and a controller controlling an operation of each of the parts.

### TECHNICAL FIELD

The present invention relates to a massage device, and more particularly, to a massage device capable of automatic sliding that can automatically move an auxiliary part supporting a lower body of a user.

### BACKGROUND ART

As a conventional massage device, “massage device” is disclosed in Korean Utility Model Registration No. 20-0236271 (hereinafter referred to as “related art”).

In the conventional massage device, power is turned on using an on/off switch of a control unit or an on/off switch of a remote controller, when a standard or local massage control signal is input to a microcomputer through a standard or local selection switch of the control unit, heat is generated from an electric heating wire embedded in a heated mat and warms the back, and at the same time, a control signal output from the microcomputer applies power to a driving motor and rotates the driving motor in a forward or reverse direction at predetermined intervals, a resultant rotation driving force thereof is reduced by a reducer, and then a driving pulley installed on an output shaft rotates clockwise or counterclockwise and pulls a wire rightward or leftward so that the wire repeatedly pulls a support rightward or leftward, first and second oilless bearings move rightward or leftward along first and second guide rails, and first and second rollers alternately rotate clockwise or counterclockwise and massage the spine, calves, and thighs.

The conventional massage device can massage the back and feet (as well as the calves and thighs) of a user while performing thermotherapy in a state in which the user is lying down in a comfortable position, can massage a specific part, and is configured to be foldable, thereby being easy to carry and easy to organize due to a reduced installation area.

However, since two support boards are mounted by a coupler such as a hinge, there is an inconvenience that, in order to unfold the support boards in a state in which each support board is folded, a user needs to directly unfold the support boards around the coupler by hand.

In addition, since each support board needs to rotate for an unfolding or folding operation, there is a problem that a stable support structure of a massage module or the like embedded in each support board cannot be guaranteed.

Therefore, there is a need to address such issues.
(Patent Document 1) Korean Utility Model Registration No. 20-0236271

### DISCLOSURE

### Technical Tasks

The present invention is directed to providing a massage device capable of automatic sliding that can automatically move an auxiliary part supporting a lower body of a user.

The present invention is also directed to providing a massage device capable of automatic sliding in which, even when only one side of an auxiliary part in a width direction is automatically moved, both sides of the auxiliary part can stably move without the auxiliary part being tilted to either side in the width direction.

The present invention is also directed to providing a massage device capable of automatic sliding that can maintain constant tension of a wire automatically moving an auxiliary part.

Objectives of the present invention are not limited to those mentioned above, and other unmentioned objectives should be clearly understood by those of ordinary skill in the art to which the present invention pertains from the description below.

### Technical Solution

One aspect of the present invention provides a massage device capable of automatic sliding that includes a main body part having a first plate supporting an upper body of a user, a pair of side frames disposed on both sides of the first plate in a width direction, and a massage module for massaging the user, an auxiliary part connected to be slidable in a longitudinal direction of the main body part and having a second plate supporting a lower body of the user and a leg frame supporting the second plate for the second plate to be disposed apart from the ground, an automatic sliding part having a conveying member connected to the auxiliary part and a driving member providing a driving force for the conveying member to automatically move, and a controller controlling an operation of each of the parts, wherein a guide rail having a movement section providing a movement path for the auxiliary part to move in a state in which a height of the auxiliary part is maintained constant and a use section providing a movement path for the auxiliary part to completely unfold is provided on the main body part, and the conveying member includes a movement bracket connected to the auxiliary part and having a length that is maintained constant whether the auxiliary part is disposed in the movement section or the use section.

Here, the use section may extend downward so that the height of the auxiliary part decreases and the second plate is disposed on an extension line of the first plate.

Here, the conveying member may further include a wire connected to the driving member for the movement bracket to automatically move, and the wire may include a first unit wire connected to one side of the movement bracket and a second unit wire connected to the other side of the movement bracket.

Here, the wire may be connected to one end of the movement bracket, and a support bar provided on one side of the auxiliary part in the width direction may be connected to the other end of the movement bracket in a hinge manner.

Here, movement paths of the one end and the other end of the movement bracket having a predetermined length may be guided by the guide rail.

Here, in a first state in which the auxiliary part is completely folded, the one end and the other end of the movement bracket may be disposed in the movement section, and in a second state in which the auxiliary part is completely unfolded, the one end of the movement bracket may be disposed in the movement section, and the other end of the movement bracket may be disposed in the use section.

Here, a first roller and a second roller that are movable along the guide rail may be provided on the one end and the other end, respectively, of the movement bracket.

Here, the wire may be connected to the one end and the other end of the movement bracket, a support bar provided on one side of the auxiliary part in the width direction and moving along the guide rail may be disposed to be inserted into the movement bracket, and a slot may be provided for the support bar to be movable in a height direction.

Here, the conveying member may further include a drum connected to a rotation shaft of the driving member, and a first support surface around which the first unit wire is wound during rotation of the drum in one direction and a second support surface around which the second unit wire is wound during rotation of the drum in the other direction may be provided on the drum.

Here, the conveying member may further include a wire cover surrounding the wire exposed to the outside of the guide rail.

Here, the conveying member may further include a drum cover disposed to surround an outer portion of the drum.

Here, a wire guide into which the wire is inserted and disposed and an elastic member providing an elastic force to the wire guide may be provided on the drum cover.

Here, in a case in which the auxiliary part unfolds and enters the use section, the controller may control the driving member to reduce a movement speed of the auxiliary part.

Here, in a case in which the auxiliary part folds and enters a predetermined region of the movement section, the controller may control the driving member to reduce the movement speed of the auxiliary part.

### Advantageous Effects

According to the above configurations, in a massage device capable of automatic sliding according to an embodiment of the present invention, since an auxiliary part can be automatically moved by a conveying member connected to the auxiliary part and an automatic sliding part having a driving member providing a driving force for the conveying member to automatically move, user convenience is improved, and in particular, since the auxiliary part is automatically moved using a movement bracket having a length that is maintained constant, the auxiliary part can stably move without being tilted to either side in a width direction.

Also, in a massage device capable of automatic sliding according to an embodiment of the present invention, when an auxiliary part unfolds, a second plate moves downward to a height at which the second plate is disposed on an extension line of a first plate, and thus the massage device can be used while a user is in a comfortable position.

Also, in a massage device capable of automatic sliding according to an embodiment of the present invention, since a movement bracket is moved through a wire connected to a driving member, the size of an automatic sliding part is reduced, which improves ease of installation and makes it possible to reduce the size of the massage device, and since the wire is divided into a first unit wire and a second unit wire and connected, the wire can be easily installed.

Also, in a massage device capable of automatic sliding according to an embodiment of the present invention, since a position at which a wire is connected and a position at which an auxiliary part is connected are separated, stable movement is possible regardless of the position at which the auxiliary part is disposed.

Also, in a massage device capable of automatic sliding according to an embodiment of the present invention, since movement paths of one end and the other end of a movement bracket having a predetermined length are guided by a guide rail, through rigidity of the movement bracket, both sides of an auxiliary part can stably move without the auxiliary part being tilted to either side in a width direction.

Also, in a massage device capable of automatic sliding according to an embodiment of the present invention, since one end of a movement bracket to which a wire is connected is disposed in a use section at all times regardless of a state (a folded state, a moving state, an unfolded state) of an auxiliary part, a height of the wire is maintained constant without changing, thereby enabling stable movement of the movement bracket and maintenance of tension of the wire.

Also, in a massage device capable of automatic sliding according to an embodiment of the present invention, since a drum having a predetermined diameter is connected to a rotation shaft of a driving member, which allows wires to be wound or unwound, and a support surface around which each wire is wound is provided, interference between the wires does not occur in a process in which each wire is wound or unwound, and stable movement of a movement bracket is possible.

Also, in a massage device capable of automatic sliding according to an embodiment of the present invention, since a wire cover surrounding a wire exposed to the outside of a guide rail and a drum cover disposed to surround an outer portion of a drum are provided, interference between the wire and another component inside the massage device does not occur in a process in which the wire is wound and unwound, and stable rotation of the drum and reduction of driving noise are possible.

Further, in a massage device capable of automatic sliding according to an embodiment of the present invention, when an auxiliary part enters a predetermined region in a process in which the auxiliary part is unfolded or folded, a movement speed of the auxiliary part is controlled to decrease, and thus impact and noise that may occur in the process in which the auxiliary part is unfolded or folded can be minimized.

It should be understood that the effects of the present invention are not limited to the above-described effects, and include all effects inferable from a configuration of the invention described in the detailed description or claims of the present invention.

### DESCRIPTION OF DRAWINGS

FIG. 1 is a perspective view illustrating a massage device capable of automatic sliding according to one embodiment of the present invention, wherein (a) of FIG. 1 is a view illustrating a state in which an auxiliary part is unfolded, and (b) of FIG. 1 is a view illustrating a state in which the auxiliary part is folded.

FIG. 2 is a perspective view illustrating an automatic sliding part provided in the massage device capable of automatic sliding according to one embodiment of the present invention.

FIG. 3 is a side view illustrating the automatic sliding part provided in the massage device capable of automatic sliding according to one embodiment of the present invention and is a view illustrating a position of a movement bracket in the state in which the auxiliary part is folded.

FIG. 4 is an enlarged view of an arrangement state of the movement bracket of FIG. 3.

FIG. 5 is a side view illustrating the automatic sliding part provided in the massage device capable of automatic sliding according to one embodiment of the present invention and is a view illustrating a position of the movement bracket in the state in which the auxiliary part is unfolded.

FIG. 6 is an enlarged view of an arrangement state of the movement bracket of FIG. 5.

FIG. 7 is an enlarged perspective view of the movement bracket provided in the massage device capable of automatic sliding according to one embodiment of the present invention.

FIG. 8 is an enlarged side view of the movement bracket provided in the massage device capable of automatic sliding according to another embodiment of the present invention.

FIG. 9 is an exploded perspective view of the automatic sliding part provided in the massage device capable of automatic sliding according to one embodiment of the present invention.

FIG. 10 is an enlarged perspective view of a drum cover provided in the massage device capable of automatic sliding according to yet another embodiment of the present invention.

FIG. 11 is a constitutional view illustrating a state in which a length of a wire of the massage device capable of automatic sliding according to still another embodiment of the present invention is adjusted.

### MODES OF THE INVENTION

Hereinafter, embodiments of the present invention will be described in detail with reference to the accompanying drawings so that those of ordinary skill in the art to which the present invention pertains can easily carry out the present invention. The present invention may be implemented in various different forms and is not limited to the embodiments described herein. In the drawings, in order to clearly describe the present invention, parts irrelevant to the description are omitted, and like or similar components are denoted by like reference numerals throughout the specification.

Words or terms used in the present specification and the claims should not be interpreted as being limited to their general or dictionary meanings and should be interpreted to have meanings and concepts consistent with the technical spirit of the present invention, according to the principle that the inventor may define terms and concepts thereof in order to describe his or her invention in the best possible way.

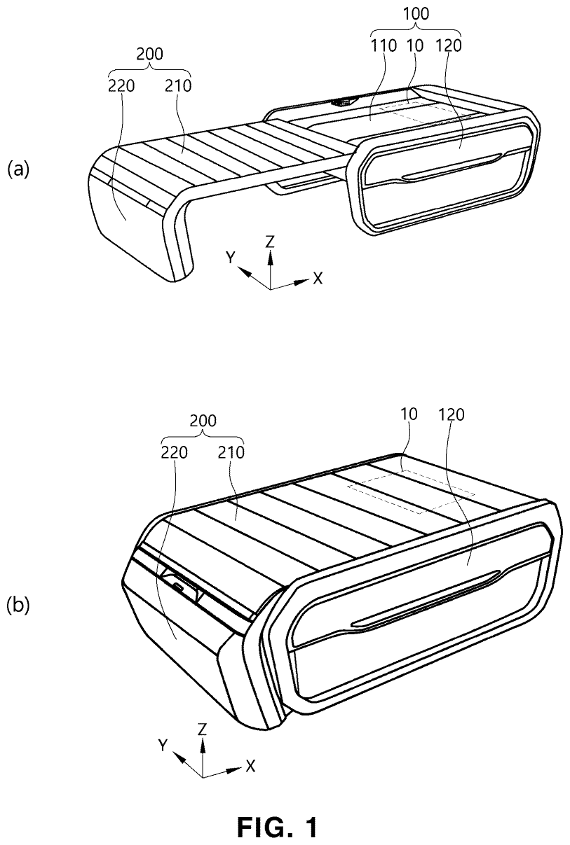

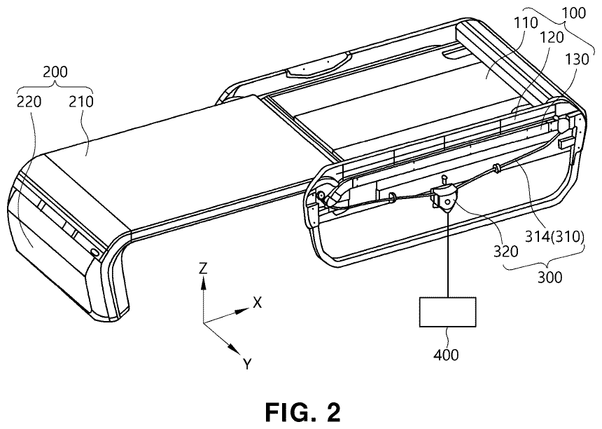

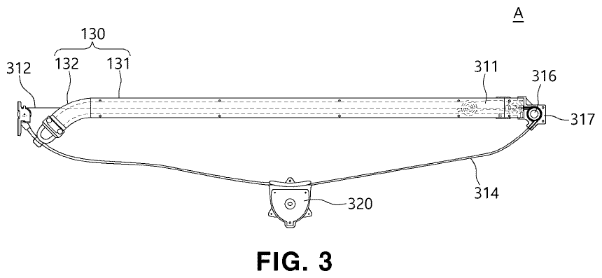

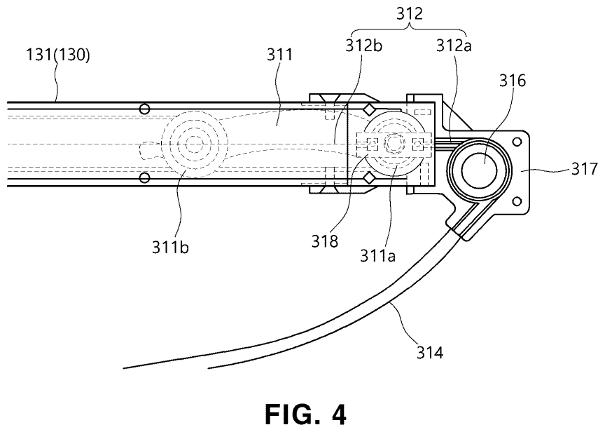

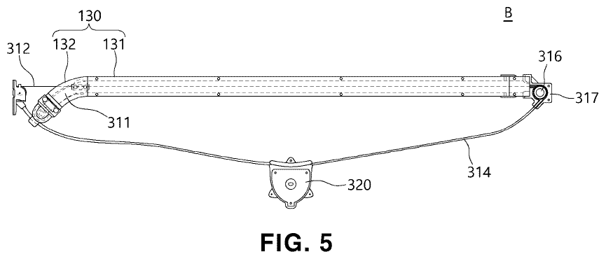

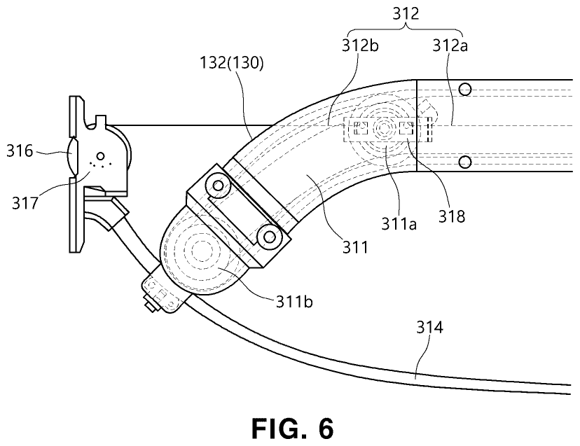

FIG. 1 is a perspective view illustrating a massage device capable of automatic sliding according to one embodiment of the present invention, wherein (a) of FIG. 1 is a view illustrating a state in which an auxiliary part is unfolded, and (b) of FIG. 1 is a view illustrating a state in which the auxiliary part is folded, FIG. 2 is a perspective view illustrating an automatic sliding part provided in the massage device capable of automatic sliding according to one embodiment of the present invention, FIG. 3 is a side view illustrating the automatic sliding part provided in the massage device capable of automatic sliding according to one embodiment of the present invention and is a view illustrating a position of a movement bracket in the state in which the auxiliary part is folded, FIG. 4 is an enlarged view of an arrangement state of the movement bracket of FIG. 3, FIG. 5 is a side view illustrating the automatic sliding part provided in the massage device capable of automatic sliding according to one embodiment of the present invention and is a view illustrating a position of the movement bracket in the state in which the auxiliary part is unfolded, and FIG. 6 is an enlarged view of an arrangement state of the movement bracket of FIG. 5. Here, the X-direction is a direction in which the auxiliary part is unfolded or folded and indicates a longitudinal direction of the massage device, the Y-direction indicates a width direction of the massage device, and the Z-direction indicates a height direction of the massage device. In the drawings, in order to clearly describe the present invention, parts irrelevant to the description are omitted.

As illustrated in FIG. 1, a massage device capable of automatic sliding according to an embodiment of the present invention includes a main body part 100 having a first plate 110 supporting the upper body of a user, a pair of side frames 120 disposed on both sides of the first plate 110 in the width direction (Y), and a massage module 10 for massaging the user, and an auxiliary part 200 connected to be slidable in the longitudinal direction (X) of the main body part 100 and having a second plate 210 supporting the lower body of the user and a leg frame 220 supporting the second plate 210 for the second plate 210 to be disposed apart from the ground.

The massage module 10 is a component for performing heat massage on the body (particularly, the spinal area) of the user, but the massage module 10 is not necessarily provided only on the main body part 100. The massage module 10 may also be provided on the auxiliary part 200 as necessary.

For example, when the massage module 10 is disposed on the main body part 100, a hole may be formed at the center of a pad, which is provided on the main body part 100 and supports the upper body of the user, in the width direction for the massage module 10 to move in the longitudinal direction. A separate moving means is provided on the massage module 10, and the massage module 10 performs massage while moving in the longitudinal direction (X).

A leg member supporting the first plate 110 for the first plate 110 to be disposed apart from the ground in the height direction (Z) may be provided on the side frames (120). In this way, the user can receive massage in a comfortable position.

The leg member may be manufactured substantially in the shape of a quadrangular band. That is, the side frames 120 corresponding to side surfaces of the main body part 100 and the leg member supported by the ground are connected. The side frames 120 and the leg member may be integrally manufactured or may be separately manufactured and then coupled. Here, the side frames 120 may be manufactured in a plate shape, and the leg member may be manufactured in a bar shape.

The auxiliary part 200 may be configured to be slidable by a guide groove being formed in the main body part 100 described above and a guide protrusion, which is inserted into the guide groove, being formed on the auxiliary part 200. Alternatively, the auxiliary part 200 may be configured to be slidable by a guide groove being formed in the auxiliary part 200 and a guide protrusion being formed on the main body part 100.

Also, as illustrated in FIG. 2, the massage device capable of automatic sliding according to an embodiment of the present invention includes an automatic sliding part 300 having a conveying member 310 connected to the auxiliary part 200 and a driving member 320 providing a driving force for the conveying member 310 to automatically move, and a controller 400 controlling an operation of each of the parts.

That is, the controller 400 controls an operation of the driving member 320, and in this way, the conveying member 310 can automatically move the auxiliary part 200, and user convenience is improved.

Further, as illustrated in FIG. 3, a guide rail 130 having a movement section 131 providing a movement path for the auxiliary part 200 to move in a state in which a height of the auxiliary part 200 is maintained constant and a use section 132 providing a movement path for the auxiliary part 200 to completely unfold is provided on the main body part 100.

When the massage module 10 is not in use, the auxiliary part 200 may be folded and stored, and an arrangement state of the automatic sliding part 300 at this time is illustrated in FIGS. 3 and 4. Also, even in the state in which the auxiliary part 200 is folded, the second plate 210 of the auxiliary part 200 is exposed to the outside, and thus the user is able to sit on the second plate 210 and use the auxiliary part 200, and here, a separate heating member such as a heating wire may be provided on the auxiliary part 200 and may be configured to provide warmth to the user.

That is, in the massage device, even in the state in which the auxiliary part 200 is folded, not only storage but also switching to a use state, in which the user is able to sit on and use the auxiliary part 200, is possible.

Also, in order to use the massage device, the user slides the auxiliary part 200 in the longitudinal direction (X) and unfolds the auxiliary part 200, and in a process in which the auxiliary part 200 moves from the front to rear of the main body part 100, the movement section 131 of the guide rail 130 provides a path of the auxiliary part 200.

The auxiliary part 200 that has moved to the rear of the main body part 100 along the movement section 131 described above moves along the use section 132 and completely unfolds. An arrangement state of the automatic sliding part 300 at this time is illustrated in FIGS. 5 and 6.

Here, as illustrated in FIGS. 3 and 4, the conveying member 310 includes a movement bracket 311 connected to the auxiliary part 200 and having a length that is maintained constant whether the auxiliary part 200 is disposed in the movement section 131 or the use section 132.

That is, since the auxiliary part 200 can be automatically moved by the conveying member 310 connected to the auxiliary part 200 and the automatic sliding part 300 having the driving member 320 providing a driving force for the conveying member 310 to automatically move, user convenience is improved, and in particular, since the auxiliary part 200 is automatically moved using the movement bracket 311 having a length that is maintained constant, the auxiliary part 200 can stably move without being tilted to either side in the width direction (Y).

As illustrated in FIGS. 5 and 6, the use section 132 may extend downward so that the height of the auxiliary part 200 decreases and the second plate 210 is disposed on an extension line of the first plate 110.

That is, the auxiliary part 200 moves a predetermined distance downward along the use section 132, and as the height of the auxiliary part 200 decreases, the height decreases to a height at which the second plate 210 is disposed on the extension line of the first plate 110, and when such as state is reached, the auxiliary part 200 completely unfolds, and the user is able to use the massage device in a comfortable position.

As illustrated in FIGS. 3 to 6, the conveying member 310 may further include a wire 312 connected to the driving member 320 for the movement bracket 311 to automatically move, and the wire 312 may include a first unit wire 312a connected to one side of the movement bracket 311 and a second unit wire 312b connected to the other side of the movement bracket 311.

That is, since the movement bracket 311 is moved through the wire 312 connected to the driving member 320, the size of the automatic sliding part 300 is reduced, which improves ease of installation and makes it possible to reduce the size of the massage device.

The wire 312 may be installed on the massage device through a support roller 316, and when the wire 312 slides according to an operation of the driving member 320, since the support roller 316 rotates accordingly and supports the wire 312, noise generated during an operation of the automatic sliding part 300 is reduced. The support roller 316 may be rotatably installed on a separate support bracket 317.

A separate joint bracket 318 for connecting the wire 312 may be provided on the movement bracket 311, the first unit wire 312a may be connected to one side of the joint bracket 318, and the second unit wire 312b may be connected to the other side of the joint bracket 318. The wire 312 may be easily installed when the wire 312 is divided into the first unit wire 312a and the second unit wire 312b and is connected using the joint bracket 318 as described above.

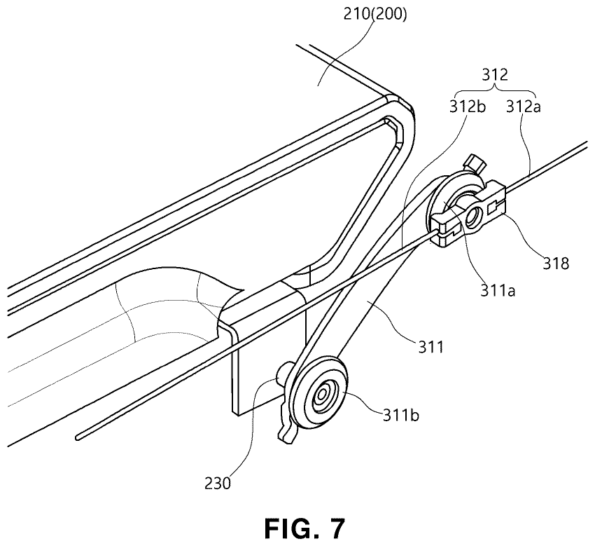

FIG. 7 is an enlarged perspective view of the movement bracket provided in the massage device capable of automatic sliding according to one embodiment of the present invention.

As illustrated in FIG. 7, the wire 312 may be connected to one end of the movement bracket 311, and a support bar 230 provided on one side of the auxiliary part 200 in the width direction (Y) may be connected to the other end of the movement bracket 311 in a hinge manner.

That is, a position at which the wire 312 is connected and a position at which the auxiliary part 200 is connected are separately configured. Although the movement section 131 and the use section 132 that are formed with different heights are formed on the guide rail 130 as described above, by separating the position at which the wire 312 is connected and the position at which the auxiliary part 200 is connected, stable movement is possible regardless of the position at which the auxiliary part 200 is disposed.

As illustrated in FIGS. 4 and 6, movement paths of the one end and the other end of the movement bracket 311 having a predetermined length may be guided by the guide rail 130.

That is, when the movement bracket 311 is provided on one side of the auxiliary part 200 in the width direction (Y), the size of the automatic sliding part 300 is reduced, which improves ease of installation, makes it possible to reduce the size of the massage device, and makes it possible to reduce manufacturing costs.

However, it is important to ensure that, even when the movement bracket 311 moves in a state in which the movement bracket 311 is provided on one side of the auxiliary part 200 in the width direction (Y), both sides of the auxiliary part 200 can stably move without the auxiliary part 200 being tilted to either side in the width direction (Y).

Therefore, the movement paths of the one end and the other end of the movement bracket 311 having a predetermined length are guided by the guide rail 130, and through rigidity of the movement bracket 311, both sides of the auxiliary part 200 can stably move without the auxiliary part 200 being tilted to either side in the width direction (Y).

Here, as illustrated in FIG. 4, in a first state (A) in which the auxiliary part 200 is completely folded, the one end and the other end of the movement bracket 311 may be disposed in the movement section 131, and as illustrated in FIG. 6, in a second state (B) in which the auxiliary part 200 is completely unfolded, the one end of the movement bracket 311 may be disposed in the movement section 131, and the other end of the movement bracket 311 may be disposed in the use section 132.

That is, the one end of the movement bracket 311 to which the wire 312 is connected is disposed in the use section 132 at all times regardless of a state (a folded state, a moving state, an unfolded state) of the auxiliary part 200, and in this way, a height of the wire 312 is configured to be maintained constant without changing.

When configured as described above, stable movement of the movement bracket 311 and maintenance of tension of the wire 312 are possible.

As illustrated in FIG. 7, a first roller 311a and a second roller 311b that are movable along the guide rail 130 may be provided on the one end and the other end, respectively, of the movement bracket 311. Through the first roller 311a and the second roller 311b, stable movement of the movement bracket 311 and reduction of driving noise are possible.

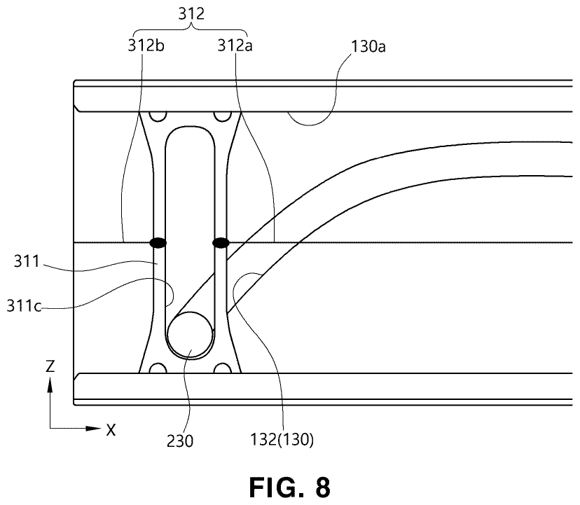

FIG. 8 is an enlarged side view of the movement bracket provided in the massage device capable of automatic sliding according to another embodiment of the present invention.

As illustrated in FIG. 8, the wire 312 may be connected to the one end and the other end of the movement bracket 311, the support bar 230 provided on one side of the auxiliary part 200 in the width direction (Y) and moving along the guide rail 130 may be disposed to be inserted into the movement bracket 311, and a slot 311c may be provided for the support bar 230 to be movable in the height direction (Z).

As described above, when the movement bracket 311 is provided on one side of the auxiliary part 200 in the width direction (Y), the size of the automatic sliding part 300 is reduced, which improves ease of installation, makes it possible to reduce the size of the massage device, and makes it possible to reduce manufacturing costs, but even in this case, it is important to ensure that both sides of the auxiliary part 200 can stably move without the auxiliary part 200 being tilted to either side in the width direction (Y), and thus the movement bracket 311 is configured to have a predetermined length in the longitudinal direction (X).

That is, the support bar 230 of the auxiliary part 200 is disposed to be inserted into the guide rail 130 and moves along the guide rail 130, and the movement bracket 311 is configured to move the support bar 230 in the longitudinal direction (X).

Here, although a height difference between the movement section 131 and the use section 132 causes a height of the support bar 230 to change in a process in which the support bar 230 moves in the longitudinal direction (X), since the slot 311c is provided, the support bar 230 is able to continuously move even when the height of the support bar 230 changes.

Also, since the movement bracket 311 moves in the longitudinal direction (X) due to the wire 312, and the height of the movement bracket 311 is constantly fixed, stable movement of the movement bracket 311 is possible, and it is easy to maintain tension of the wire 312.

Further, a separate auxiliary rail 130a providing a movement path of the movement bracket 311 may be provided on the main body part 100.

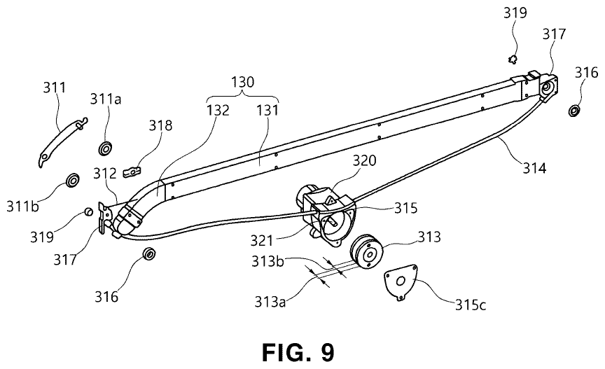

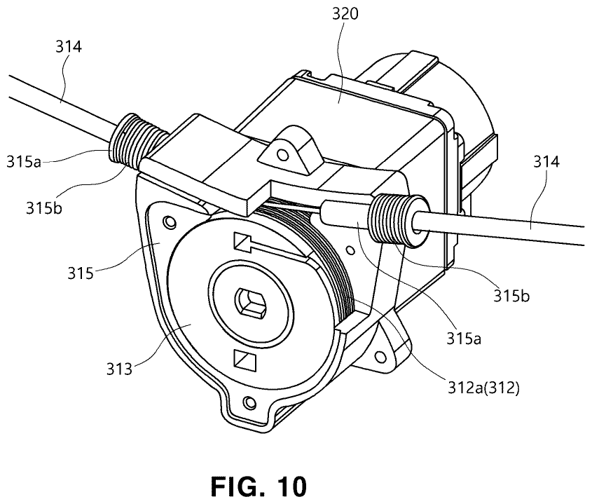

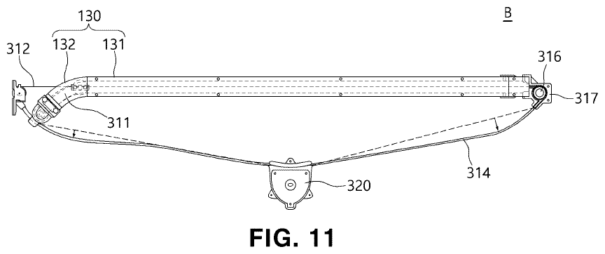

FIG. 9 is an exploded perspective view of the automatic sliding part provided in the massage device capable of automatic sliding according to one embodiment of the present invention, FIG. 10 is an enlarged perspective view of a drum cover provided in the massage device capable of automatic sliding according to yet another embodiment of the present invention, and FIG. 11 is a constitutional view illustrating a state in which a length of the wire 312 of the massage device capable of automatic sliding according to still another embodiment of the present invention is adjusted.

As illustrated in FIGS. 9 and 10, the conveying member 310 may further include a drum 313 connected to a rotation shaft 321 of the driving member 320, and a first support surface 313a around which the first unit wire 312a is wound during rotation of the drum 313 in one direction and a second support surface 313b around which the second unit wire 312b is wound during rotation of the drum 313 in the other direction may be provided on the drum 313.

That is, since the drum 313 having a predetermined diameter is connected to the rotation shaft 321 of the driving member 320, which allows the wires 312 to be wound or unwound, stable movement of the movement bracket 311 is possible.

In addition, since the first support surface 313a around which the first unit wire 312a is wound and the second support surface 313b around which the second unit wire 312b is wound are provided on the drum 313, interference between the wires 312 does not occur in a process in which each wire 312 is wound or unwound according to rotation in the one direction or the other direction, and stable movement of the movement bracket 311 is possible.

Here, separate sensors 319 for detecting winding and unwinding of the wires 312 may be provided, and as the sensors 139, a sensor 319 for detecting winding and unwinding of the first unit wire 312a and a sensor 319 for detecting winding and unwinding of the second unit wire 312b may be separately installed.

As illustrated in FIG. 10, the conveying member 310 may further include a wire cover 314 surrounding the wire 312 exposed to the outside of the guide rail 130. When the wire cover 314 is provided in this way, interference between the wire 312 and another component inside the massage device does not occur in a process in which the wire 312 is wound and unwound, and driving noise can be reduced.

In addition, the conveying member 310 may further include a drum cover 315 disposed to surround an outer portion of the drum 313, and through the drum cover 315, interference with another component inside the massage device can be prevented, and stable rotation of the drum 313 and reduction of driving noise are possible.

A separate cover 315c may be provided on the drum cover 315 to be able to open and close an inner space in which the drum 313 is installed.

Here, as illustrated in FIG. 10, a wire guide 315a into which the wire 312 is inserted and disposed and an elastic member 315b providing an elastic force to the wire guide 315a may be provided on the drum cover 315. That is, since the wire 312 is wound around or unwound from the drum 313 through the wire guide 315a in a state in which the wire guide 315a is installed on the drum cover 315, a stable operation of the wire 312 is possible, and driving noise is reduced.

For example, the elastic member 315b may be a coil spring applying an elastic force to the wire guide 315a, but any other component such as a leaf spring may be used as long as the component can apply an elastic force to the wire guide 315a.

Also, when the elastic member 315b is provided on the wire guide 315a as described above, it becomes easy to assemble the drum 313, around which the wire 312 is wound, to the drum cover 315. This will be described in detail below.

For example, a design length of the wire 312 is a sum of a length of the wire wound around the drum 313, a length from the drum 313 to support rollers 316 at both sides, and a length between the support rollers 316 at both sides, and when it is assumed that the design length of the wire 312 necessary for automatic movement of the auxiliary part 200 is 2 m, in order to assemble the drum 313 to the drum cover 315 after the wire 312 is wound around the drum 313, the actual length of the wire 312 needs to be configured to be slightly longer than the design length. This is to assemble the rotation shaft 321 of the driving member 320 in a state in which the wire 312 is wound around the drum 313.

Therefore, when the wire 312 is configured to be about 3 cm longer, the actual length of the wire 312 is 2.03 m, and when the length is configured to be about 3 cm longer in this way, a clearance may be formed between the wire 312 and the support roller 316, and a problem of the wire 312 deviating from the support roller 316 in a process in which the auxiliary part 200 moves may also occur, but when the elastic member 315b is provided on the wire guide 315a as illustrated in FIG. 11, in a process in which the elastic member 315b is elastically restored as an external force is removed after the drum 313 is assembled, the length of the elastic member 315b increases, and the elastic member 315b pushes the wire cover 314, and as much as the wire cover 314 is pushed, a curvature is formed in the wire cover 314, and a path through which the wire 312 should pass between the drum cover 315 and the support roller 316 increases (changes from the dotted line to the solid line), and as a result, even when the overall length of the wire 312 is about 3 cm longer, it is possible to prevent formation of a clearance between the wire 312 and the support roller 316.

Further, manufacturing tolerance may sometimes occur in the length of the wire 312 in the process of manufacturing the wire 312, but since a degree of elastic restoration of the elastic member 315b varies as described above, formation of a clearance between the wire 312 and the support roller 316 due to the manufacturing tolerance can be prevented.

Here, the controller 400 may control the driving member to reduce a movement speed of the auxiliary part 200 when the auxiliary part 200 unfolds and enters the use section 132.

That is, in a case in which the auxiliary part 200 unfolds, when the auxiliary part 200 enters the use section 132, the movement speed of the auxiliary part 200 is controlled to decrease, and since the use section 132 extends downward, it is possible to minimize impact and noise that may occur as the auxiliary part 200 falls due to gravity along the use section 132.

For example, the controller 400 may control the movement speed of the auxiliary part 200 to gradually decrease linearly.

Also, in a case in which the auxiliary part 200 folds and enters a predetermined region of the movement section 131, the controller 400 may control the driving member 320 to reduce the movement speed of the auxiliary part 200. In this way, it is possible to minimize impact and noise that may occur as the auxiliary part 200 collides with the main body part 100 in a process in which the auxiliary part 200 is completely folded.

As described above, in the massage device capable of automatic sliding according to an embodiment of the present invention, since the auxiliary part 200 can be automatically moved by the conveying member 310 connected to the auxiliary part 200 and the automatic sliding part 300 having the driving member 320 providing a driving force for the conveying member 310 to automatically move, user convenience is improved, and in particular, since the auxiliary part 200 is automatically moved using the movement bracket 311 having a length that is maintained constant, the auxiliary part 200 can stably move without being tilted to either side in the width direction (Y).

Embodiments of the present invention have been described above, but the spirit of the present invention is not limited by the embodiments presented herein, and those of ordinary skill in the art who understand the spirit of the present invention may easily propose other embodiments by adding other components, changing components, or omitting components within the scope of the same spirit. However, such embodiments also belong to the scope of the spirit of the present invention.

1. A massage device capable of automatic sliding, the massage device comprising:
a main body part having a first plate supporting an upper body of a user, a pair of side frames disposed on both sides of the first plate in a width direction, and a massage module for massaging the user;
an auxiliary part connected to be slidable in a longitudinal direction of the main body part and having a second plate supporting a lower body of the user and a leg frame supporting the second plate for the second plate to be disposed apart from the ground;
an automatic sliding part having a conveying member connected to the auxiliary part and a driving member providing a driving force for the conveying member to automatically move; and
a controller controlling an operation of each of the parts,
wherein a guide rail having a movement section providing a movement path for the auxiliary part to move in a state in which a height of the auxiliary part is maintained constant and a use section providing a movement path for the auxiliary part to completely unfold is provided on the main body part, and
the conveying member includes a movement bracket connected to the auxiliary part and having a length that is maintained constant whether the auxiliary part is disposed in the movement section or the use section.

2. The massage device of claim 1, wherein the use section extends downward so that the height of the auxiliary part decreases and the second plate is disposed on an extension line of the first plate.

3. The massage device of claim 1, wherein:
the conveying member further includes a wire connected to the driving member for the movement bracket to automatically move; and
the wire includes a first unit wire connected to one side of the movement bracket and a second unit wire connected to the other side of the movement bracket.

4. The massage device of claim 3, wherein:
the wire is connected to one end of the movement bracket; and
a support bar provided on one side of the auxiliary part in the width direction is connected to the other end of the movement bracket in a hinge manner.

5. The massage device of claim 4, wherein movement paths of the one end and the other end of the movement bracket having a predetermined length are guided by the guide rail.

6. The massage device of claim 5, wherein:
in a first state in which the auxiliary part is completely folded, the one end and the other end of the movement bracket are disposed in the movement section; and
in a second state in which the auxiliary part is completely unfolded, the one end of the movement bracket is disposed in the movement section, and the other end of the movement bracket is disposed in the use section.

7. The massage device of claim 6, wherein a first roller and a second roller that are movable along the guide rail are provided on the one end and the other end, respectively, of the movement bracket.

8. The massage device of claim 3, wherein the wire is connected to the one end and the other end of the movement bracket, a support bar provided on one side of the auxiliary part in the width direction and moving along the guide rail is disposed to be inserted into the movement bracket, and a slot is provided for the support bar to be movable in a height direction.

9. The massage device of claim 3, wherein:
the conveying member further includes a drum connected to a rotation shaft of the driving member; and
a first support surface around which the first unit wire is wound during rotation of the drum in one direction and a second support surface around which the second unit wire is wound during rotation of the drum in the other direction are provided on the drum.

10. The massage device of claim 9, wherein the conveying member further includes a wire cover surrounding the wire exposed to the outside of the guide rail.

11. The massage device of claim 9, wherein the conveying member further includes a drum cover disposed to surround an outer portion of the drum.

12. The massage device of claim 11, wherein a wire guide into which the wire is inserted and disposed and an elastic member providing an elastic force to the wire guide are provided on the drum cover.

13. The massage device of claim 1, wherein, in a case in which the auxiliary part unfolds and enters the use section, the controller controls the driving member to reduce a movement speed of the auxiliary part.

14. The massage device of claim 13, wherein, in a case in which the auxiliary part folds and enters a predetermined region of the movement section, the controller controls the driving member to reduce the movement speed of the auxiliary part.
